(19) United States
(12) Patent Application Publication
(10) Pub. No.: US 2015/0170616 A1
(43) Pub. Date: Jun. 18, 2015

(54) LOCAL DATA QUALITY HEATMAP

(71) Applicant: Google Inc., Mountain View, CA (US)

(72) Inventors: Pascal CORPET, Gockhausen (CH); Ammar IBRAHIM, Zurich (CH); Iyad F. I. ASSAD, Ruschlikon (CH); Patrick Pui Wah LEUNG, Paris (FR)

(73) Assignee: Google Inc., Mountain View, CA (US)

(21) Appl. No.: 13/842,008

(22) Filed: Mar. 15, 2013

Related U.S. Application Data
(60) Provisional application No. 61/639,800, filed on Apr. 27, 2012.

(51) Int. Cl. G09G 5/377

(52) U.S. Cl. CPC G09G 5/377

(57) ABSTRACT

Computer-implemented methods for determining and providing a local data quality heatmap based on local data quality parameters of points of interest and/or a geographic area are provided. In one aspect, the level of local data quality is visually represented by a local data quality heatmap that is combined with a geographic map and presented to the user. Systems and machine-readable media for generating a local data quality heatmap are also provided.

### CROSS-REFERENCE TO RELATED APPLICATIONS

The present application claims the benefit of priority under 35 U.S.C. §119 from U.S. Provisional Patent Application Ser. No. 61/639,800, filed on Apr. 27, 2012, the disclosure of which is hereby incorporated by reference in its entirety for all purposes.

### BACKGROUND

The present disclosure generally relates to heatmaps, and more particularly to using user generated content to generate a heatmap to provide a visual indication of local data quality.

Applications such as search engines and mapping applications may provide a visual indication on a map of the quality of data (e.g., local data quality) for various points of interest (e.g., business, store, restaurant, landmark). The spatiality of a set of measures (e.g., data associated with local data quality) may be displayed as points (e.g., pixels, icons) on the map. However, displaying points for map areas that have a high density of points may be unreadable and of little use to a user in determining the local data quality within a point or area of the map. It is desirable to provide an effective and informative way in which to visually indicate the local data quality of a point of interest or area on a map.

### SUMMARY

According to one aspect of the disclosure, a computer implemented method for representing local data quality on a map is provided. The method includes obtaining a map of a geographical area containing at least one point of interest, wherein each point of interest is associated with a listing. The method also includes generating by a processor a first layer comprising at least one region, wherein each region is based on the local data quality of the points of interest within the region, wherein the local data quality of each point of interest is based on at least one local data quality parameter. The method further includes superimposing the first layer on the map, providing a representation of local data quality levels for one or more areas of the map corresponding to the one or more regions of the first layer. The method also includes providing the map and the first layer for display on a user device.

According to another aspect of the disclosure, a system for representing local data quality on a map is provided. The system includes a memory that stores executable instructions and a processor configured to execute the executable instructions. The system is configured to obtain a map of a geographical area containing one or more points of interest, wherein each point of interest is associated with a listing. The system is also configured to generate a first layer comprising at least one region, wherein each region is based on the local data quality of the points of interest within the region, wherein the local data quality of each point of interest is based on at least one local data quality parameter comprising staleness of a listing, completeness of a listing, geographical accuracy of a listing, or coverage density of listings. The system is also configured to superimpose the first layer on the map to provide a representation of local data quality levels for one or more areas of the map corresponding to the one or more regions of the first layer. The system is further configured to provide the map and first layer for display on a user device.

According to a further aspect of the disclosure, a non-transitory machine-readable storage medium comprising machine-readable instructions for causing a processor to execute a method for representing local data quality on a map is provided. The method includes obtaining a map of a geographical area containing at least one point of interest associated with a listing. The method also includes generating by a processor a heat map comprising at least one region, wherein each region is based on the local data quality of the points of interest within the region, wherein the local data quality of each point of interest is based on at least one local data quality parameter. The method further includes superimposing the heat map on the map, providing a representation of local data quality levels for one or more areas of the map corresponding to the one or more regions of the heat map.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for determining a most local data quality;

FIG. 2 is a block diagram illustrating an example client and server from the architecture of FIG. 1 according to certain aspects of the disclosure;

FIG. 3 illustrates an example display of a heatmap combined with a geographical map;

FIG. 4 illustrates an example process for generating a local data quality heatmap; and

FIG. 5 is a block diagram illustrating an example computer system with which the client and server of FIG. 2 may be implemented.

### DETAILED DESCRIPTION

In the following detailed description, numerous specific details are set forth to provide a full understanding of the present disclosure. It will be apparent, however, to one ordinarily skilled in the art that the implementations of the present disclosure may be practiced without some of these specific details. In other instances, well-known structures and techniques have not been shown in detail so as not to obscure the disclosure.

The disclosed system provides extensible map rendering to display a geographic topology containing points of interest such as ATMs, restaurants, business, or hotels, for example. Additional layers may be superimposed on top of the map to provide visual information to a user regarding the local data quality of the points of interest within the area. Local data quality is a representation of the quality of data or information associated with points of interest or geographical regions in compiled listings of points of interests and/or geographical regions. The data or information in the listings may include geographic location information, street address, telephone numbers, associated categories or classifications, etc.

Local data quality and coverage for mapping may be very low, particularly in emerging markets. One approach to improving the local data quality is to utilize user generated content provided by local users to update or supplement the listings. Therefore, a visual representation of the local data quality of a particular geographic area may be helpful to such users so that the users may easily see which geographical areas would benefit from improved quality. A user may then provide new or updated information that improves the local data quality of a point of interest or geographical area on the map.

For example, the local data quality of a point of interest such as a restaurant may be represented by any of the accuracy of a listed location for the restaurant, the completeness of the information listed for the restaurant (e.g., phone number, address, pictures) and the staleness of the information (e.g., the length of time since new data for the restaurant was last encountered). Another form of local data quality may be the coverage of the area, such as the number of listings for a geographical area of the map. A user may receive a map of a nearby area having a superimposed layer showing that a particular neighborhood has low data quality. The user may then provide additional data that is missing from the restaurant listing, such as a phone number and a new picture. The user may also provide listing information for another restaurant across the street that is not currently listed, for example. These new user updates may be used to improve the local data quality of the area.

The superimposed layer on the map may be in the in the form of a heatmap. For example, a fog layer may be superimposed over a map of a geographical area in which the fog varies in intensity and/or color to signify the local data quality of different regions of the map. The fog may be more opaque over a region with low local data quality and the fog may be more transparent over a region having increased local data quality. Alternatively, the heatmap may be represented by a plurality of polygons in which any of the size, shape and/or color of the polygon may represent the local data quality. For example, the polygons may be associated with local area features (e.g., city boundaries, county boundaries). Alternatively, the polygons may be associated with local linear features (e.g., polygons between road networks) or the polygons may be abstract and defined by the system (e.g., regular hexagon pavement), for example. In yet another alternative, the visualization mechanism may utilize icons that indicate areas of varying local data quality, for example. A different layer may be used for each form of local data quality, or a combination of different forms of local data quality may be represented by one layer.

Users with knowledge of a particular geographic area may provide updated local data quality information and the superimposed layer may be re-rendered to provide the user with a visualization of the improved quality. The user may choose varying levels of granularity regarding the points of interest. For example, the initial presentation may provide listings of general business categories such as hotels, restaurants and bank ATMs, but the user may then pick a very specific category to visualize and provide updated information associated with the specific category (e.g. shoe retailers that cater specifically to women).

For example, a contest or game may be provided that allows users to win prizes or accolades for improving the local data quality of an area. A user may send a query asking for the local data quality of a specific city. The system may send a current geographical map of the city with a superimposed heatmap having varying levels of fog opaqueness visually representing corresponding levels of local data quality in the city. The user may then choose a block of the city with very low data quality that is displayed as very opaque fog. The user may then provide updated information or parameters on businesses, stores, restaurants, parks and other points of interest in that block, for example. The system may then calculate new local data quality values for each point of interest and for the city block area. The system may then use the new local data quality values to regenerate a new fog layer superimposed on the geographical map of the city, where the fog over the city block having the updated information is more transparent. The degree of the transparency may depend upon a relative degree of local data quality that is normalized such that specific degree of transparency represents the same level of local data quality over any area of the map that it is superimposed.

As another example, the system may provide multiple layers superimposed over the geographical map, where each layer represents a different local data quality parameter. For example, it may have been several months since information was updated regarding the city block or any of the points of interest in the city block, so a layer may be generated that is specifically based on a staleness factor of the local data quality. Another layer may be generated that is associated with a completeness factor that is based upon the number of completed and/or updated information elements related to each point of interest or to the city block. Each layer may be displayed using a different color and/or shape of polygon or a different colored fog, for example. The user may be able to turn layers on and off such that the user may be able to look at the local data quality based on only one factor.

The system may also provide zoom levels associated with a heatmap. The heatmap may change according to the zoom level of the map. For example, the heatmap may change continuously as the zoom level is changed (e.g., the heatmap becomes more transparent as the zoom is increased to go further in, or the heatmap changes colors as the zoom level changes). Alternatively, the system may provide multiple heatmaps where each heatmap is associated with a different zoom level, for example. The zoom levels may be created and/or handled by a server, a client or any combination of a server and a client, for example.

While many examples are provided herein in the context of generating a local data quality heatmap, the principles of the present disclosure contemplate other aspects of heatmaps as well. For example, merging the heatmap and the geographic map by either a server or a client device, comparing local data quality of different areas, and discerning geographical patterns using local data quality, are all considered within the scope of the present disclosure.

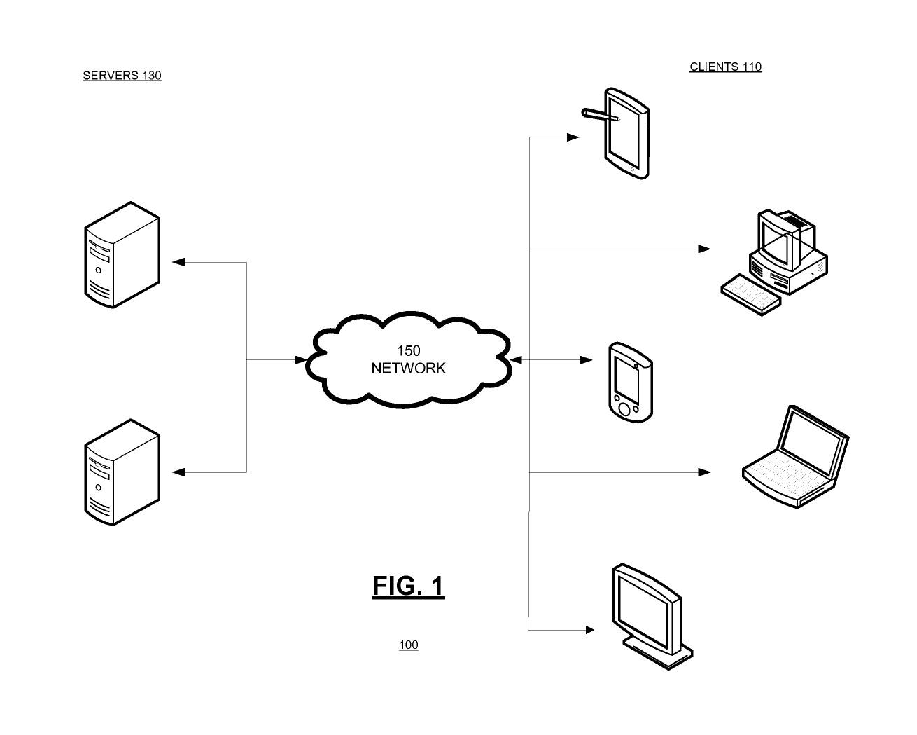

Turning to the drawings, FIG. 1 illustrates an example architecture 100 for generating a local data quality heatmap superimposed on a geographical map and displaying the combined map on a device. The architecture 100 includes servers 130 and clients 110 connected over a network 150.

Each of the clients 110 is configured to run an information interface (e.g., web browser or other application) that provides access to applications and/or information related to local data quality of points of interest and geographical areas. The web browser or other application is configured to run on clients 110 that are mobile or non-mobile. The clients 110 may be, for example, user devices such as desktop computers, laptop computers, mobile devices (e.g., a smartphone, tablet computer, or PDA), set top boxes (e.g., for a television), video game consoles, or any other devices having processor, memory, and communications capabilities.

The local data quality information may be downloaded over the network 150 from one or more servers 130. Multiple servers 130 may host the data for generating local data quality heatmaps and/or downloading local data quality information. The servers 130 may be any device having processor, memory, and communications capability for generating local data quality heatmaps and/or hosting data related to generating local data quality heatmaps. The network 150 may include, for example, any one or more of a personal area network (PAN), a local area network (LAN), a campus area network (CAN) a metropolitan area network (MAN), a wide area network (WAN), a broadband network (BBN), the Internet, and the like. Further, the network 150 may include, but is not limited to, any one or more of the following network topologies, including a bus network, a star network, a ring network, a mesh network, a star-bus network, tree or hierarchical network, and the like.

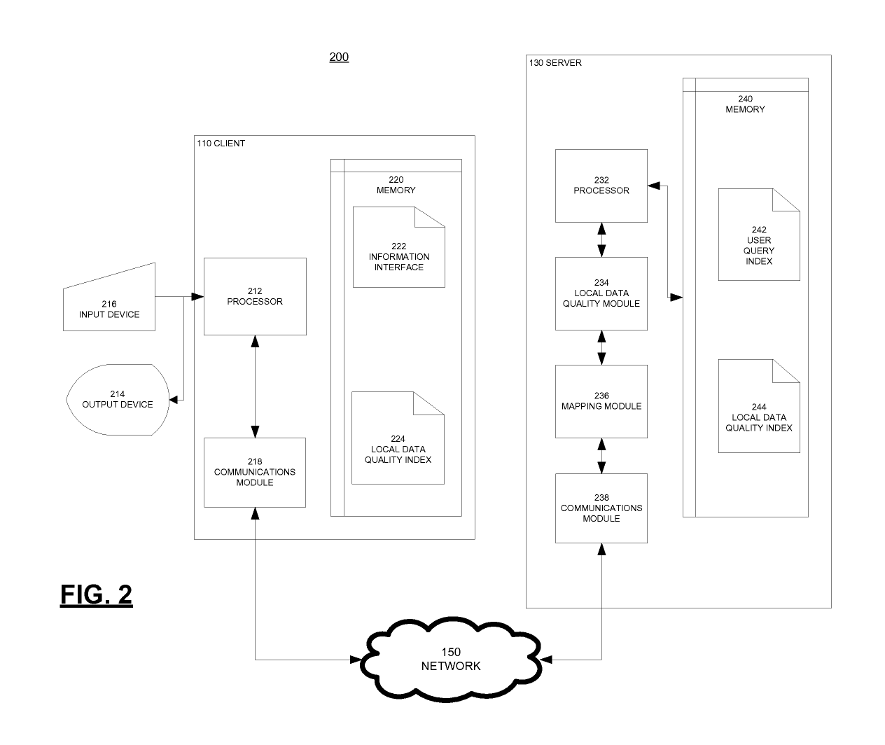

FIG. 2 is a block diagram 200 illustrating an example server 130 and client 110 in the architecture 100 of FIG. 1 according to certain aspects of the disclosure. The client 110 and the server 130 are connected over the network 150 via client communications module 218 and server communications module 238. The communications modules 218 and 238 are configured to interface with the network 150 to send and receive information, such as data, requests, responses, and commands to other devices on the network. The communications modules 218 and 238 may be, for example, modems or Ethernet cards and may be configured as transmitters and/or receivers.

The client 110 includes a client processor 212, the client communications module 218, and a client memory 220 that includes an information interface 222, such as a web browser, for example. The client memory 220 may also include a local data quality index 224 for storing information such as local data quality heatmaps, geographical maps and associated local data quality information, for example. The client 110 also includes an output device 214, such as a display, to provide information to the user, and an input device 216, such as a keyboard, touchscreen, or mouse, to receive user inputs. The local data quality information is received from the server 130 over the network 150 using respective communications modules 218 and 238 of the client 110 and server 130. Specifically, the server 130 generates one or more local data quality heatmaps to provide to the client 110 in response to the server 130 performing a local data quality calculation based on a user's query regarding a point of interest or a geographical area. Alternatively, the client 110 may be configured to perform any or all of the functions required to determine the local data quality related to a point of interest or a geographical area, such that the server 130 is not required to provide information or is only required to provide local data quality parameters, information or factors used in making the calculations, for example. The client 110 may also include a location tracking system (e.g., global positioning system (GPS)) that may send the current position of the client 110 to the server 130 and the server 130 may then send a local map of the area to the client 110, for example.

The server 130 includes a server processor 232, the server communications module 238, and a server memory 240. The server processor 232 is configured to execute instructions, such as instructions physically coded into the server processor 232, instructions read from the server memory 240, or a combination of both. For example, the server processor 232 executes instructions from the server memory 240 to generate a local data quality heatmap based on currently known local data quality information or updated local data quality information provided by the user. The server 130 may include a mapping module 236, with the associated data, and point of interest listings. The mapping module 236 may be configured to retrieve the points of interest from the listings to populate maps requested by the client 110. A local data quality module 234 may be configured to determine the quality of the listings and communicate the determined local data quality to the mapping module 236 to generate the heat map layer(s). The local data quality module 234 may be integrated into the mapping module 236 or remain separate and communicate with the mapping module 236 via an application programming interface (API). The local data quality information may be stored in the server memory 240, received from other sources (e.g., other servers, sensors, clients), or a combination of both. For example, a user query regarding local data quality of a point of interest may be stored in a user query index 242, local data quality information associated with the point of interest may be stored in a local data quality index 244, and a geographical map of an area that includes the point of interest may be provided by another server.

The server processor 232 may use any suitable algorithm, formula, function or the like to calculate local data quality values, generate a local data quality heatmap based on the calculations, and provide the local data quality heatmap to the client 110. The server processor 232 may also superimpose one or more local data quality heatmaps onto a geographical map and provide the combined map to the user, such as a geographic map of a city with a composite of several individual heatmaps overlaid or superimposed on the city map, for example. Alternatively, the client processor 212 may perform a portion of or all of any of calculating the local data quality value, generating the heatmap, or merging the heatmap and the geographical map. Further, any or all of the information used in the local data quality calculation, heatmap generation or superimposing the heatmap on the geographical map may be stored in the client memory 220.

By way of example, a user may query a mapping application regarding the local data quality associated with retail stores specializing in products for babies that are in a specific city. The system obtains or generates a geographical map of the city and obtains a current listing for each baby store located in the city. The listings may include information such as the geographic location and/or phone number of the baby store, a picture of the baby store, and a category or classification of the baby store. The completeness of the listing (e.g., how much of this information is shown in the listing) may vary from store to store. The system then calculates a local data quality value for each baby store located in the city, based on the listings. Alternatively, the system may use a previously determined local data quality value for any or all of the targeted baby stores.

A heatmap is generated by the system based on the local data quality values that have been obtained or calculated for each baby store. The heatmap may represent each baby store using identically sized triangles that vary in color from red to yellow to green, where red indicates a low local data quality value, yellow indicates a medium local data quality value and green indicates a high local data quality value. The colors may be further granulated by using varying shades of each color to indicate weaker and stronger local data quality values within the color band, for example. The system overlays or superimposes the color polygon heatmap on top of the geographical map of the city and provides the merged map to the user. The user may display the merged map to be able to visually discern the varying degrees of local data quality for all of the baby stores located in the city.

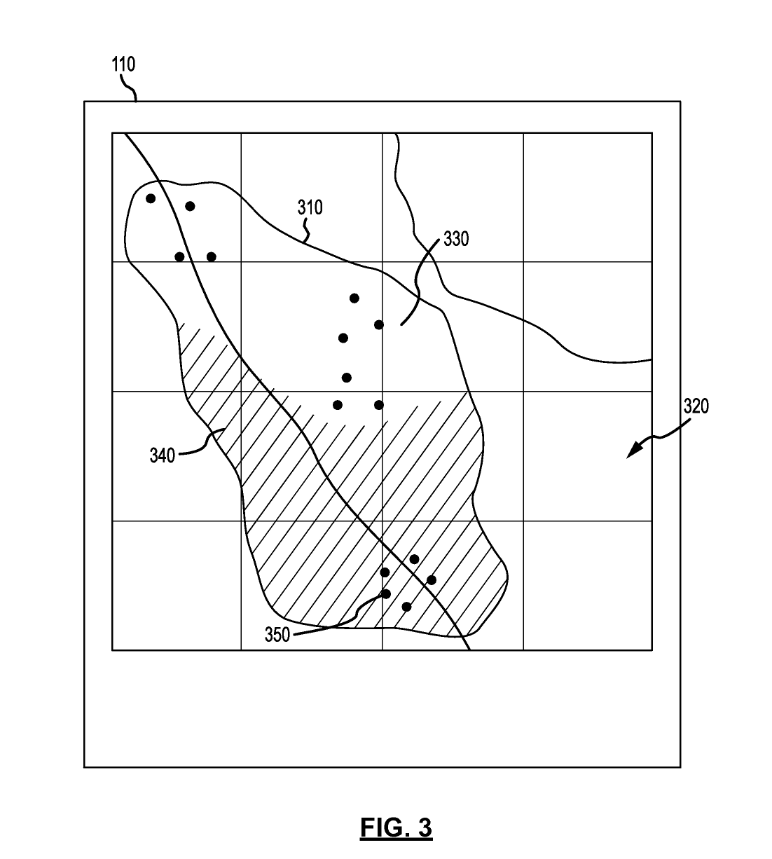

FIG. 3 illustrates an example of a local data quality heatmap 310 superimposed on a geographical map 320 and displayed on a user device. The local data quality heatmap 310 is a visual representation of the local data quality of the points of interest that are located within the area defined by the geographical map 320. The local data quality heatmap 310 may have varying degrees of transparency or opaqueness based on one or more local data quality parameters. For example, the local data quality heatmap 310 may include a first region 330 that is relatively transparent, indicating a high level or high density of local data quality, and a second region 340 that is relatively opaque, indicating a low level or low density of local data quality. The geographical map 320 may also include a point of interest indicator 350 for any or all points of interest within the defined area. For example, large or well known points of interest such as stadiums, tourist attractions and government buildings may be marked on the geographical map 320 by point of interest indicators 350 such as icons or text, for example.

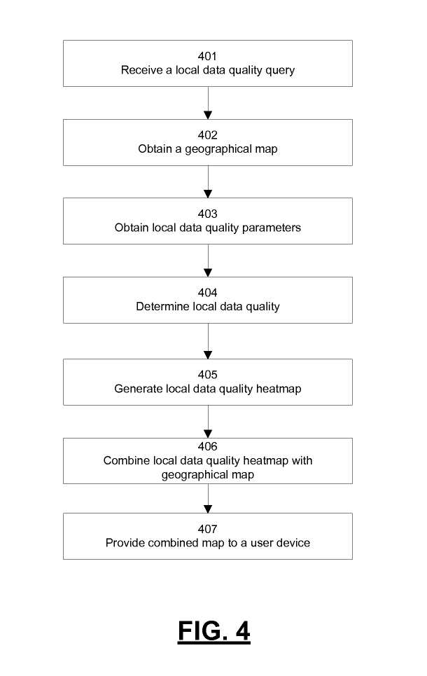

FIG. 4 illustrates an example process 400 using the example server 130 and client 110 of FIG. 2 for generating and providing a local data quality heatmap to a user. The process 400 begins at step 401 when a query regarding local data quality of a point of interest or area is received. The local data quality query may be directly created by the user asking for local data quality information. Alternatively, the local data quality query may be indirectly created, such as in response to the user's location or a search by the user. For example, the user may be part of a group that is improving local data quality for a certain type of point of interest, and a local data quality query may be automatically generated when the user travels to a location or conducts an online search for information about an area. The local data quality query may further be stored in a memory. For example, the local data quality query may be created on a server 130 and stored in a server memory 240, created on a client 110 and then sent to and stored in a server memory 240, or created on a client 110 and stored in a client memory 220.

Proceeding to step 402, a geographical map of an area containing at least one point of interest is obtained. The geographical map may be obtained from the server memory 240 or from another server, for example. Alternatively, the geographical map may be generated by the server 130 in response to the local data quality query. The geographical map may be of any geographical area of interest, such as a country, a region, a state, a city or a block of a city, for example.

In step 403, at least one local data quality parameter associated with at least one point of interest within the area defined by the geographic map is obtained by the server 130. For example, a local data quality parameter may be the completeness of a listing for a point of interest containing information elements about the point of interest, such as a phone number, an address, a category, a description, or a picture. Another local data quality parameter may be the geographical accuracy of the listing, which may be based on the confidence that the Geocode location of a point of interest is accurately listed. For example, the system may consider the source providing the location information of the point of interest and how recently the current location information was provided to determine how accurate the listed location of the point of interest is considered to be. Yet another local data quality parameter may be the staleness of the listing, which may be the length of time that has passed since new or updated information was provided for the listing. Another local data quality parameter may be based on the coverage or density of listings in an area. For example, a region may have only a few listings, yet there may be many more points of interest located in the region than are shown in the listings. Any other suitable local data quality parameter may be obtained by the server 130 as well.

A local data quality for a point of interest is determined by the server 130 in step 404. For example, the local data quality of a point of interest or an area may be calculated by the server 130 using one or more local data quality parameters. Alternatively, the local data quality for a point of interest may have been previously determined and stored in the server memory 240, or be provided by another server, for example. An application may maintain a listing of the current local data quality for points of interest in the area shown by the geographical map, for which the local data quality of a point of interest may be recalculated based on a periodic time interval or only when a local data quality parameter has changed, for example. Alternatively, the local data quality of any or all points of interest within a determined area of a geographical map may be initially calculated or recalculated after receiving a local data quality query.

In step 405, a local data quality heatmap is generated by the server 130 based on the determined local data quality of the points of interest. The local data quality heatmap may be a single layer that is superimposed over the geographical map in which the single layer is based on one or more local data quality parameters. For example, a single layer based on a combination of a staleness factor, a completeness factor, an accuracy factor and a density (e.g., coverage) factor may be generated as a local data quality heatmap. Any combination of suitable local data quality parameters may be used to generate the local data quality heatmap.

Alternatively, the local data quality heatmap may be formed from multiple layers. For example, a first layer may be generated based on a completeness factor or parameter and a second layer may be generated based on an accuracy factor or parameter. The server 130 may individually superimpose each layer on the geographical map, for example. Alternatively, the server 130 may generate each layer individually, combine the layers into a single combined layer, and then superimpose the combined layer onto the geographical map. The server 130 may also obtain one or more layers from another server or an application.

In step 406, the server 130 may combine the local data quality heatmap with the geographical map, such as by overlaying or superimposing the local data quality heatmap on the geographical map, for example. The process ends in step 407 in which the server 130 may provide the combined map to be displayed on a client 110. Alternatively, the server 130 may separately provide the local data quality heatmap and the geographical map to be combined by another server, a system or a client 110. Individual layers of a local data quality heatmap may be separately combined with the geographical map by any suitable combination of servers, systems and clients. For example, a server 130 may combine a first layer of a local data quality heatmap and a geographical map, provide the combined map to another server that then adds a second layer of a local data quality heatmap to the combined map. As another example, a server 130 may generate and provide a local data quality heatmap to a client device 110, another server may provide a geographical map to the client device 110, and the client device 110 may superimpose the received local data quality heatmap on the received geographical map.

A local data quality heatmap may be configured to provide control over individual layers. For example, a local data quality heatmap formed from a plurality of layers may be configured such that each layer may be turned on or off. Thus, a user may be able to see a geographical map of a particular area of interest with a variety of visual representations of local data quality in the area of the geographical map. For example, a geographical map of a city may be displayed and the user may then be able to separately see a visual representation of the local data quality of the city based on different local data quality parameters such as accuracy, completeness and coverage or density.

A local data quality heatmap may be useful for additional types of analysis. For example, covering an area of a geographic map with single dots or icons for each point of interest may not provide a useful display, so showing the number of points of interest on a heatmap using polygons or fog may make the display of the points of interest visible. In another example, a coverage parameter may be used to reveal incorrect information, such as showing all hotels in the geographic map area that do not contain a hotel name in the listing. Heatmaps using polygons or fog allow for easy comparison of local data quality across separate areas. A local data quality heatmap may also reveal geographical patterns. For example, a local data quality heatmap of Europe with regard to restaurants for which the restaurant listing is missing a phone number may reveal that France, western Switzerland and Belgium have poor local data quality in this regard, which may focus further analysis that may quickly pinpoint the reason being that the algorithms have a problem with the French language used in these regions.

Each of steps 401 through 407 may be performed by any combination of servers 130, clients 110 or computer systems. For example, all of steps 401 through 407 may be performed by a single server 130, or each of the steps may be performed by a different server. Alternatively, any or all of steps 401 through 407 may be performed by a client 110 that is the user's device, or by any combination of the user device client 110, other clients, servers and computer systems, for example.

Process 400 may be started by a user providing new or updated information regarding a listing for a point of interest. The process 400 may modify at least one local data quality parameter based on the received user input and generate a new first layer having one or more new regions based upon the modified at least one data quality parameter. This process may be done on the fly such that an updated heatmap may be provided for display on a user device shortly after the user provides the new of updated information, for example.

An example will now be described using the example process 400, a server 130, a server memory 240, a user query index 242, a local data quality index 244, a heatmap 310, a geographical map 320, a network 150, a smartphone client 110, an output device 214 and a mobile web browser 222, as shown in FIGS. 1-4.

The process 400 begins when a user uses a mobile web browser 222 on the user's smartphone 110 to search for information on the local data quality of restaurants associated with a four block area in the user's neighborhood in the city. In step 401, the server 130 receives and stores the local data quality query in a local data quality query index 242 in a server memory 240. In step 402, the server 130 obtains a previously rendered geographical map 320. The server 130 obtains a set of staleness, accuracy, completeness and density parameters associated with each restaurant in step 403. In step 404, the server 130 determines a local data quality for each restaurant and for the coverage of the four block area, which is stored in the local data quality index 244 of the server memory 240. In this example, the local data quality is determined to be highest for the first block and lowest for the second block, while being almost equal for the third and fourth blocks.

The server 130 generates a local data quality heatmap 310 based on the determined local data quality for each restaurant and block in step 405. In this example, the local data quality heatmap 310 includes four layers where each layer is based on one of the local data quality factors or parameters. Also in this example, each layer is visually represented by fog in which the fog is most transparent in the region of the geographical map 320 having the highest local data quality for the factor or parameter that the layer is based on, and the fog is most opaque in the region of the geographical map 320 having the lowest local data quality for the factor or parameter that the layer is based on.

In step 406, the server 130 superimposes the local data quality heatmap 310 on top of the geographical map 320. In this example, the fog over the first block is very transparent, the fog over the second block is quite thick or opaque, and the fog over the third and fourth block is in between. In step 407, the combined map is sent by the server 130 over the network 150 to the smartphone client 110, where it is displayed on the display 214 of the smartphone 110. The user may be able to quickly see that the second block has the lowest local data quality and proceed to provide updated information on listings for the restaurants in the second block in order to improve the local data quality there. The server 130 may then rerun steps 401 through 407 to provide a new local data quality heatmap to the user's smartphone 110 so that the user may see the results of the updated information.

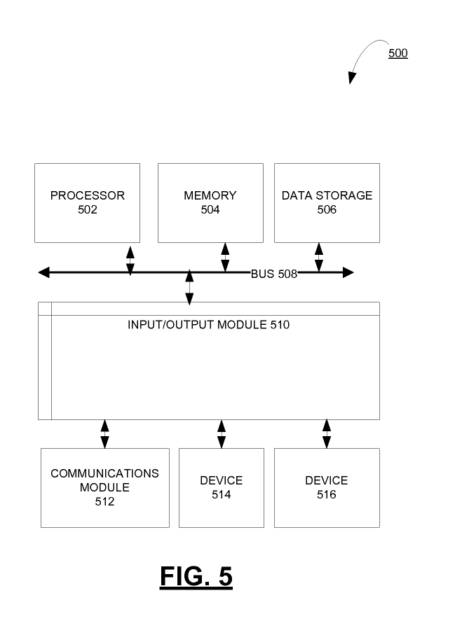

FIG. 5 is a block diagram illustrating an example computer system 500 with which the client 110 and server 130 of FIG. 2 may be implemented. In certain aspects, the computer system 500 may be implemented using hardware or a combination of software and hardware, either in a dedicated server, or integrated into another entity, or distributed across multiple entities.

Computer system 500 (e.g., client 110 and server 130) includes a bus 508 or other communication mechanism for communicating information, and a processor 502 (e.g., processor 212 and 232) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 500 may include, in addition to hardware, code that creates an execution environment for the computer program in question (e.g., code that constitutes processor firmware, a protocol stack, a database management system, an operating system, or a combination of one or more of them) stored in an included memory 504 (e.g., memory 220 and 240), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 may be supplemented by, or incorporated in, special purpose logic circuitry.

The instructions may be stored in the memory 504 and implemented in one or more computer program products, e.g., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 304 may also be used for storing temporary variable or other intermediate information during execution of instructions to be executed by processor 502.

A computer program as discussed herein does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one computer or on multiple computers that are located at one site or distributed across multiple sites and interconnected by a communication network. The processes and logic flows described in this specification may be performed by one or more programmable processors executing one or more computer programs to perform functions by operating on input data and generating output.

Computer system 500 further includes a data storage device 506 such as a magnetic disk, solid state disk (SSD) or optical disk, coupled to bus 508 for storing information and instructions. Computer system 500 may be coupled via input/output module 510 to various devices. The input/output module 510 may be any input/output module. Example input/output modules 510 include data ports such as USB ports. The input/output module 510 is configured to connect to a communications module 512. Example communications modules 512 (e.g., communications modules 218 and 238) include networking interface cards, such as Ethernet cards and modems. In certain aspects, the input/output module 510 is configured to connect to a plurality of devices, such as an input device 514 (e.g., input device 216) and/or an output device 516 (e.g., output device 214). Example input devices 514 include a keyboard and a pointing device, e.g., a mouse or a trackball, by which a user may provide input to the computer system 500. Other kinds of input devices 514 may be used to provide for interaction with a user as well, such as a tactile input device, visual input device, audio input device, or brain-computer interface device. For example, feedback provided to the user may be any form of sensory feedback (e.g., visual feedback, auditory feedback, or tactile feedback); and input from the user may be received in any form, including acoustic, speech, tactile, or brain wave input. Example output devices 516 include display devices, such as a cathode ray tube (CRT) or liquid crystal display (LCD) monitor, for displaying information to the user.

According to one aspect of the present disclosure, the client 110 and server 130 may be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back end component (e.g., as a data server), or that includes a middleware component (e.g., an application server), or that includes a front end component (e.g., a client computer having a graphical user interface or a Web browser) through which a user may interact with an implementation of the subject matter described in this specification, or any combination of one or more such back end, middleware, or front end components. The components of the system may be interconnected by any form or medium of digital data communication (e.g., a communication network). The communication network (e.g., network 150) may include, for example, any one or more of a personal area network (PAN), a local area network (LAN), a campus area network (CAN), a metropolitan area network (MAN), a wide area network (WAN), a broadband network (BBN), the Internet, a cloud and the like. Further, the communication network may include, but is not limited to, for example, any one or more of the following network topologies, including a bus network, a star network, a ring network, a mesh network, a star-bus network, tree or hierarchical network, or the like. The communications modules may be, for example, modems or Ethernet cards.

Computing system 500 may include clients and servers. A client and server are generally remote from each other and typically interact through a communication network. The relationship of client and server arises by virtue of computer programs running on the respective computers and having a client-server relationship to each other. Computer system 500 may be, for example, and without limitation, a desktop computer, laptop computer, or tablet computer. Computer system 500 may also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions to processor 502 for execution. Such a medium may take many forms, including, but not limited to, non-volatile media and volatile media, for example. Non-volatile media include, for example, optical or magnetic disks, such as data storage device 506. Volatile media include dynamic memory, such as memory 304. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer may read. The machine-readable storage medium may be a machine-readable storage device, a machine-readable storage substrate, a memory device, or a combination of one or more of them.

Systems, methods, applications, and machine-readable storage media for generating and providing a local data quality heatmap have been described. While this specification contains many specifics, these should not be construed as limitations on the scope of what may be disclosed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially disclosed as such, one or more features from a disclosed combination may in some cases be excised from the combination, and the disclosed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products.

The subject matter of this specification has been described in terms of particular aspects, but other aspects may be implemented and are within the scope of the following claims. For example, the actions recited in the claims may be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

The subject technology is illustrated, for example, according to various aspects described below. Various examples of aspects of the subject technology are described as numbered claims 1, 2, 3, etc.) for convenience. These are provided as examples, and do not limit the subject technology.

What is claimed is:

1. A computer-implemented method for representing local data quality on a map, the method comprising:
obtaining a map of a geographical area containing at least one point of interest, wherein each point of interest is associated with a listing;
generating by a processor a first layer comprising at least one region, wherein each region is based on the local data quality of the points of interest within the region, and wherein the local data quality of each point of interest is based on at least one local data quality parameter;
superimposing the first layer on the map, providing a representation of local data quality levels for one or more areas of the map corresponding to the one or more regions of the first layer; and
providing the map and the first layer for display on a user device.

2. The computer-implemented method of claim 1, wherein the local data quality parameter comprises a staleness factor of the listing, wherein the staleness factor is based on the last time an information element about the point of interest was updated.

3. The computer-implemented method of claim 1, wherein the local data quality parameter comprises a completeness factor of a listing, wherein the completeness factor is based on how many information elements about the point of interest are complete in the listing.

4. The computer-implemented method of claim 1, wherein the local data quality parameter comprises an accuracy factor of a listing, wherein the accuracy factor is based on the geographic accuracy of the listing of the location of the point of interest.

5. The computer-implemented method of claim 1, wherein the local data quality parameter comprises a density factor, wherein the density factor is based on the number of listings for points of interest within the region.

6. The computer-implemented method of claim 1, wherein the first layer comprises a heatmap providing a visual representation of the local data quality of each area of the map.

7. The computer-implemented method of claim 6, wherein the heatmap comprises a fog having an opaqueness level associated with each region, wherein the opaqueness level is determined based upon the local data quality level of the corresponding area of the map.

8. The computer-implemented method of claim 6, wherein the heatmap comprises at least one polygon having a visual attribute comprising shape and color, wherein the visual attribute is determined based upon the local data quality level of the corresponding area of the map.

9. The computer-implemented method of claim 6, wherein the heatmap comprises a different visual representation for each of a plurality of zoom levels of the map.

10. The computer-implemented method of claim 1, wherein the first layer comprises a polygon map providing a visual representation of the local data quality of each area of the map.

11. The computer-implemented method of claim 1, wherein the superimposing the first layer on the map is done by a server.

12. The computer-implemented method of claim 1, wherein the superimposing the first layer on the map is done by the user device

13. The computer-implemented method of claim 1, further comprising:
receiving user input regarding new information associated with a point of interest;
modifying the at least one local data quality parameter based on the received user input; and
generating a new first layer comprising one or more new regions based upon the modified at least one data quality parameter.

14. The computer-implemented method of claim 1, further comprising:
generating a second layer comprising one or more regions based upon at least one local data quality parameter associated with the one or more points of interest, wherein the second layer is based upon at least one different local data quality parameter than the first layer is based upon;
superimposing the second layer on the map; and
providing the map, the first layer and the second layer to be displayed on the user device.

15. The computer-implemented method of claim 14, wherein the superimposing at least one of the first layer and the second layer on the map is done by a server.

16. The computer-implemented method of claim 14, wherein the superimposing at least one of the first layer and the second layer on the map is done by the user device.

17. A system for representing local data quality on a map, the system comprising:
a memory storing executable instructions; and
a processor configured to execute the executable instructions, causing the system to:
obtain a map of a geographical area containing one or more points of interest, wherein each point of interest is associated with a listing;
generate a first layer comprising at least one region, wherein each region is based on the local data quality of the points of interest within the region, wherein the local data quality of each point of interest is based on at least one local data quality parameter comprising staleness of a listing, completeness of a listing, geographical accuracy of a listing, or coverage density of listings;
superimpose the first layer on the map to provide a representation of local data quality levels for one or more areas of the map corresponding to the one or more regions of the first layer; and
provide the map and first layer for display on a user device.

18. The system of claim 17, wherein the processor is further configured to:
receive user input regarding new information associated with a point of interest;
modify the at least one local data quality parameter based on the received user information,
wherein a new first layer comprising one or more new regions is dynamically generated based upon the modified at least one data quality parameter, and
wherein the modified at least one data quality parameter represents one of a new local data quality parameter and a change in an existing local data quality parameter.

19. The system of claim 18, wherein the processor is further configured to:
generate a second layer comprising one or more regions based upon at least one local data quality parameter associated with the one or more points of interest, wherein the second layer is based upon at least one different local data quality parameter than the first layer is based upon;
superimpose the second layer on the map; and
provide the map, the first layer and the second layer to be displayed on the user device.

20. A non-transitory machine-readable storage medium comprising machine-readable instructions for causing a processor to execute a method for representing local data quality on a map, the method comprising:
obtaining a map of a geographical area containing at least one point of interest associated with a listing;
generating by a processor a heatmap comprising at least one region, wherein each region is based on the local data quality of the points of interest within the region, wherein the local data quality of each point of interest is based on at least one local data quality parameter; and
superimposing the heatmap on the map, providing a representation of local data quality levels for one or more areas of the map corresponding to the one or more regions of the heatmap.

21. The non-transitory machine-readable storage medium of claim 20, the method further comprising:
generating a second layer comprising one or more regions based upon at least one local data quality parameter associated with the one or more points of interest, wherein the second layer is based upon at least one different local data quality parameter than the first layer is based upon;
superimposing the second layer on the map; and
providing the map, the first layer and the second layer to be displayed on a user device.
